(19) United States
(12) Patent Application Publication
(10) Pub. No.: US 2010/0009793 A1
(43) Pub. Date: Jan. 14, 2010

(54) TENSIONING DEVICE

(76) Inventors: James Payne, Chillicothe, OH (US); Keith Crinkey, Springfield, OH (US)

Correspondence Address: FAY SHARPE LLP, 1228 Euclid Avenue, 5th Floor, The Halle Building, Cleveland, OH, 44115, US

(21) Appl. No.: 12/497,360

(22) Filed: Jul. 2, 2009

Related U.S. Application Data
(60) Provisional application No. 61/077,672, filed on Jul. 2, 2008.

(51) Int. Cl. F16H 7/12

(52) U.S. Cl. 474/136

(57) ABSTRACT

A tensioning apparatus includes a first C-shaped beam frame spaced apart from a second C-shaped beam frame. A first air cylinder is suspended from the first beam frame and a second air cylinder is mounted on the second beam frame. A carriage assembly is situated adjacent to the first and the second air cylinders. At least two pairs of guide members are supported on opposing corners of a support member of the carriage assembly. The pairs of guide members guide the carriage assembly along a longitudinal extent of the first and the second beam frames. The guide members travel along distal edges of flanges of the beam frames. A power operated means actuates movement of the carriage assembly along the first and second beam frames. A rope guide sheave is supported by the carriage assembly for free rotation.

### CLAIM OF PRIORITY

The present application claims priority from U.S. provisional application Ser. No. 61/077,672, filed Jul. 2, 2008, which is incorporated by reference herein.

### BACKGROUND OF THE DISCLOSURE

The present disclosure is directed generally toward a rope tensioning apparatus and, more particularly, to an apparatus that includes at least two spaced apart beam frames that are situated exterior to air cylinders secured thereon.

Known apparatuses for producing a web of paper direct at least one continuous rope several times around multiple rolls for threading and pinching a tail of a web through the rolls. The continuous rope requires substantial take-up to maintain a desired tension; however, the rolls are driven at speeds in excess of 17 feet/second, which can cause the continuous rope to stretch up to ten percent in length over a period of use.

Therefore, rope stretchers preferably maintain constant tension in the continuous rope. Some known rope stretchers include elongate frames that support moveable carriages. Flexible cables extend from the carriages and around moveable pulleys, which are supported by extendable piston rods of fluid cylinders. One known construction, shown in U.S. Pat. No. 5,379,932, eliminates the pulley system by supporting and guiding the carriages along an elongate H-shape beam frame. A problem with this system is because the fluid cylinders are mounted to the interconnecting web portion of the H-beam; their outermost surfaces are exposed to moisture, dust, and other contaminants that can affect the moving components of the fluid cylinders. A cover guard can be secured to an outer flange of the H-beam in one embodiment; however, such guard is an additional component that further requires utilization of brackets. Thus, there exists a need to cover the fluid cylinders without additional components and construction.

Another problem with existing rope stretchers is that the H-beam must support weight and provide stability to a plurality of components in the rope stretcher apparatus. The interconnecting web portion of the H-beam supports both air cylinders, the carriage pulled along its inner flange, and a cover guard secured thereon. Furthermore, if there exists a problem (i.e., an obstruction, etc.) along one of the two longitudinal edges (i.e., tracks) that hinder a movement of a guide wheel (mounted to a carriage assembly), the entire apparatus must be disassembled from the H-beam. More specifically, all guide rollers would have to be removed from the inner flange of the H-beam, and the air cylinders must be removed from the H-beam and re-secured to the H-beam.

Hence, there exists a need for a construction of a rope tensioning apparatus having multiple components that can be easily removed from the frame assembly for repair or replacement.

### SUMMARY OF THE DISCLOSURE

In accordance with one aspect of the disclosure, a tensioning apparatus includes a first frame spaced apart a distance from a second frame. A first air cylinder is suspended from the first frame and a second air cylinder is mounted on the second frame such that the first and the second air cylinders are each situated between the first and the second frames. A carriage assembly is situated adjacent to the first and the second air cylinders. At least two pairs of guide members are supported on opposing corners of a support member of the carriage assembly. The pairs of guide members guide the carriage assembly along a longitudinal extent of the first and the second beam frames. A power operated means actuates movement of the carriage assembly along the first and second frames. One of the pairs of guide members travel along a distal end of the first frame and another of the pairs of guide members travel along a distal end of the second frame. A rope guide sheave is supported by the carriage assembly for free rotation.

In accordance with a second aspect of the disclosure, a tensioning apparatus includes a first elongate C-shaped beam frame spaced apart from a second elongate C-shaped beam frame. At least one carriage assembly includes a plate member that is situated adjacent to the first and the second C-shaped beams. A first pair of guide members is mounted on the carriage assembly proximate a first longitudinal edge of the plate member. A second of guide members is mounted on the carriage assembly proximate an opposite longitudinal edge of the plate member such that the first and the second guide members are laterally spaced apart. A power operated means actuates movement of the carriage assembly along the first and the second C-shaped beams. A rope guide sheave is supported by the carriage assembly for free rotation.

Still another aspect of the disclosure is a dual tensioning apparatus including two pairs of beam frames, wherein each pair includes a first elongate beam spaced apart from a second elongate beam. A first air cylinder is suspended from the first elongate beam frame and a second air cylinder is mounted on the second elongate beam frame. At least four pairs of guide members are provided, wherein each pair of guide members returnably moves along an inner distal edge of one of the beam frames. A plate member is included on each of at least two carriage assemblies, for supporting two pairs of guide members. The plate members are generally perpendicular to and adjacent to one of the first and second pairs of beam frames. Longitudinal edges of the plate members generally coincide in a same transverse plane of which distal edges of the beam frames are situated. The apparatus further includes a power operated means for actuating movement of the carriage assemblies along the pairs of beam frames. Rope guide sheaves are supported by each of the carriage assemblies for free rotation.

Another aspect of the disclosure is a pair of frames which allows easy disassembly or removal of components for repair and replacement.

Still another aspect of the disclosure is the provision of C-shaped beam frames which act as covers or guides for internal components of the tensioning apparatus.

Still other aspects of the disclosure will become apparent upon a reading of the following detailed description.

### BRIEF DESCRIPTION OF THE DRAWINGS

FIG. 1 is a perspective view of an existing tensioning apparatus;

FIG. 2 is a cross-sectional side view of an existing dual tensioning apparatus, taken across a longitudinal cross-section of the apparatus;

FIG. 3 is a cross-sectional side view of a dual tensioning apparatus according to a preferred embodiment of the present disclosure, taken along a longitudinal cross-section of the apparatus; and,

FIG. 4 is a top cross-sectional view of one of the tensioning apparatus of FIG. 3.

### DETAILED DESCRIPTION OF THE DISCLOSURE

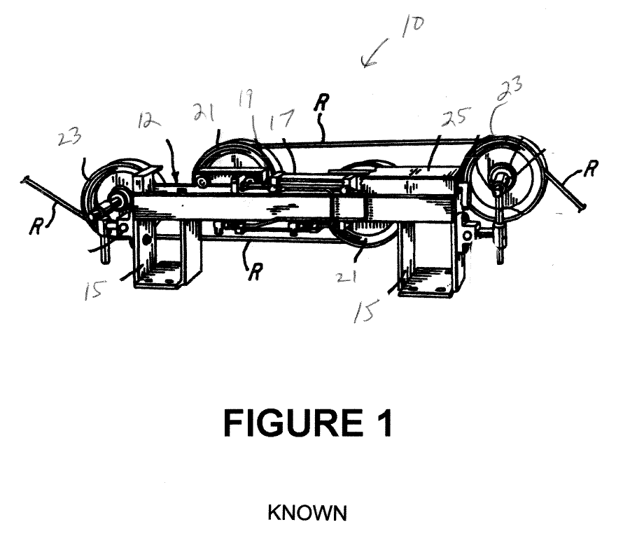

An existing tensioning apparatus 10 is shown in FIG. 1 to include an H-shaped beam 12 and support brackets 15 for the beam. Air cylinders 17 are mounted on each side of the beam and each includes a piston rod 19. A pair of sheaves 21 move longitudinally along the beam. Rope R extends under guide sheaves 23 and more than 180° degrees around sheaves 21. A cover 25 may extend the full length of beam 12.

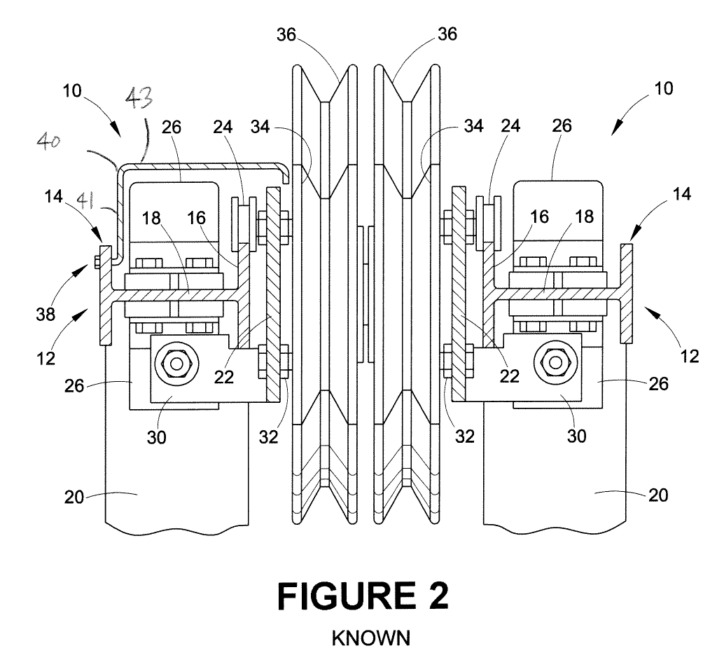

A known dual tensioning apparatus 10 is shown in FIG. 2 to include an elongate H-shape beam frame 12 having a pair of spaced apart, parallel flanges 14, 16 and an interconnecting web portion 18 extending between the pair of flanges. The flanges 14, 16 are supported by mounting brackets 20 approximately situated at terminal ends of the apparatus 10. The innermost flange 16 of the H-beam 12 supports a carriage, which includes a carriage plate 22 having a lateral length that is greater than the adjacent flange. A lateral length (i.e., height) of the carriage plate 22 extends along and beyond an entire lateral extent (i.e., height) extent of the adjacent flange 16. Guide wheels 24 are mounted on four corners of the carriage plate 22 to engage opposite longitudinally extending top and bottom edge portions of the adjacent inner flange 16. The edge portions essentially acts as a track; the guide wheel 24 supports the carriage plate 22 for movement along the length of the H-beam 12.

A pair of elongated fluid or air cylinders 26 is secured to the interconnecting web portion 16 of the H-beams 12 for each of the carriages. A first of each pair of cylinders 26 is located on a first side of the interconnecting web portion 16 and a second of each pair of cylinders 26 is situated on an opposite side of the interconnecting portion 18. Therefore, the H-beam 12 is situated between the pair of cylinders 26. A bore included on a laterally extending link member 30 receives a rod of the cylinder 26. Screws 32 secure the link member to the carriage plate 22. Axial movement of the piston rod of each cylinder 26 moves the corresponding carriage and a carriage supported rope sheave 34 longitudinally of the track formed by the supporting beam flange 16. Air pressure supplied from an air supply line urges the piston rod(s) outwardly, and thus the carriages urge toward an opposite end of the H-beam 12. An endless rope extends under one of multiple end guide sheaves 36 and more than 180° around each of the carriage supported sheaves 34 and then over the other one of the multiple end guide sheaves 36 before it extends around components of a papermaking machine. Brackets 38 support a metal cover guard 40 along a full length of the H-beam 12. The brackets 38 are secured to an outer surface of the outermost flange 14 of the H-beam 12. From the outer flange 14, the metal cover guard 40 includes a first leg 41 that extends parallel to the carriage plate 22 and a second leg 43 that extends perpendicularly therefrom toward the carriage plate.

The H-beam 12 of the known tensioning apparatus 10 must be able to support the air cylinders 26, the cover guard 40 and the carriage plate 22 moving along its top edge. More specifically, the first of the air cylinders 26 is suspended from the first surface of the interconnecting web portion 18 while the second of the air cylinders is mounted (i.e., supported) on the opposite, second surface of the interconnecting web portion. A disadvantage associated with this construction is that the cover guard 40 is an additional component in assembly, and it only wraps around the second, mounted air cylinder, thus leaving the first, suspended air cylinder exposed to fluid and debris. A second disadvantage is that the entire assembly must be disassembled from the H-beam to repair or replace components.

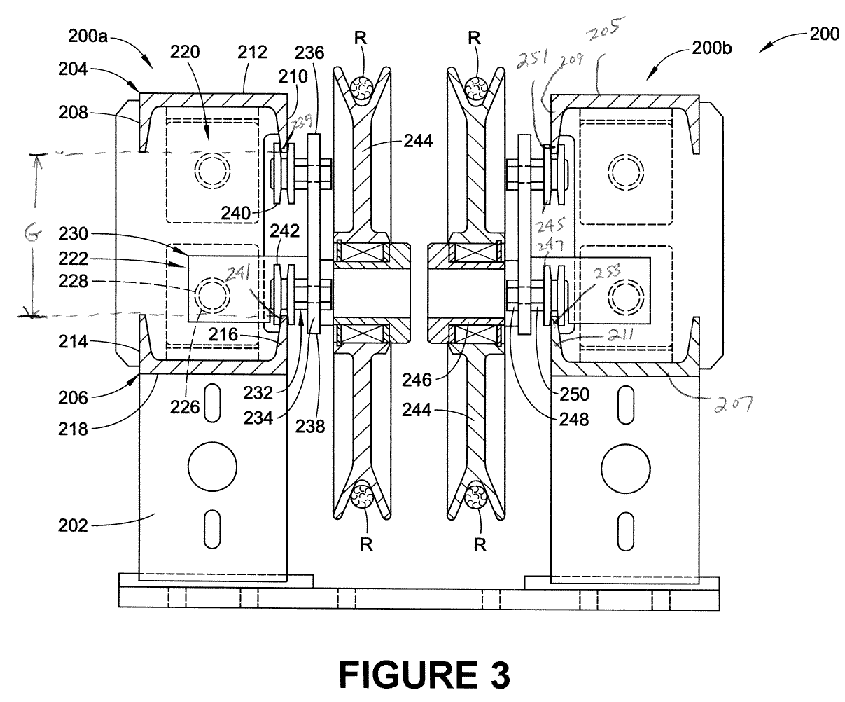

A rope tensioning apparatus 200 in accordance with a preferred embodiment of the present disclosure, is shown in FIG. 3. FIG. 3 is a cross-sectional view similar to that shown in FIG. 2, which is also taken across a longitudinal cross-section of the existing apparatus. The apparatus 200 is shown as a dual tensioning apparatus, wherein a pair of rope stretchers 200a, 200b is arranged in adjacent parallel relation to form a double rope stretcher, which handles a pair of continuous ropes R; however, embodiments are contemplated which include only one rope stretcher 200a, or 200b per apparatus. The improved rope tensioning apparatus 200 is constructed to direct a continuous length of rope R around a series of rolls. Specifically, the apparatus 200 includes at least two end plates 202 that support a weight of and maintain stability of a first pair of corresponding elongate upper and lower beam frames 204, 206 or a second pair of upper and lower beam frames 205, 207. The end plates are provided as a support means for supporting the beam frames 204, 206 and 205, 207; however, the disclosure is not limited to any one type of support means. Any support member capable of supporting the weight and maintaining the stability of the beam frames 204, 206 is contemplated by the disclosure. The elongate beam frames 204, 206 directly oppose and face one another, and frames 205, 207 oppose each other; however, there is no limitation made herein that both beam frames 204, 206 or 205, 207 in the pair are congruent in shape or that the pair mirror each other when they are situated opposite one another. The beam frames 204, 206 and 205, 207 of the preferred embodiment are each substantially C-shaped beam frames. The beam frames 204, 206, 205, 207 can be manufactured from any sturdy metal or metal combination, such as, for example, steel. The dimensions of the beam frames 204, 206 and 205, 207 are selected according to a length and expected stretch of the continuous rope R utilized with the apparatus 10 and a desired tension within the rope.

The construction of beam frames 205, 207 is substantially the same as beam frames 204, 206. Thus, only frames 204, 206 will be discussed. FIG. 3 shows the first beam frame 204 including a first outer flange 208 generally parallel to and spaced apart from a first inner flange 210. The first outer flange 208 and the first inner flange 210 depend downwardly from a first interconnecting portion 212 generally perpendicular to flanges 208, 210. The second beam frame 206 includes a second outer flange 214 generally parallel to and spaced apart from a second inner flange 216. The second outer flange 214 and the second inner flange 216 extend upwardly from a second interconnecting portion 218 which is generally perpendicular to the flanges 214, 216. In the preferred embodiment, the flange portions 208, 210, 214, 216 projects from opposing distal, longitudinal edges of the first and second interconnecting portions 212, 218.

In the illustrated embodiment, the first interconnecting portion 212 is generally parallel to the second interconnecting portion 218, and the first outer flange 208 rests in the same plane (shown as a vertically-extending plane in the illustrated embodiment) as the second outer flange 214, and the first inner flange 210 rests in generally the same (vertically-extending) plane as the second inner flange 216. There is no limitation made herein to a width (i.e., height) of the flanges 208, 210, 214, 216. The flanges 208, 210, 214, 216 are shown in the illustrated embodiment to be of generally equal heights but they can be of unequal heights as well.

A first elongate fluid or air cylinder 220 is suspended from the first or upper interconnecting portion 212. A second elongate fluid or air cylinder 222 is mounted above the second or lower interconnecting portion 218. The first and second air cylinders 220, 222 are each situated between the respective flanges 208, 210, 214, 216. Thus, one advantage associated with this construction is that the beam frames 204, 206 can provide an additional function as cover guards to prevent moisture, debris, and other contaminants from affecting the moving components of the air cylinders 220, 222. The air cylinders 220, 222 are secured to the beam frames 204, 206 by any mechanical means, such as, for example, by conventional fasteners or screws.

The air cylinders 220, 222 each includes a piston rod 226 having an outer end portion that is threaded. The outer end of the piston rod 226 is received within a bore 228 formed through a laterally projecting link member 230. The bore 228 is formed parallel to or coincident with a longitudinal axis of the air cylinder 220, 222. Each piston rod 226 is inserted into the bore along the longitudinal axis.

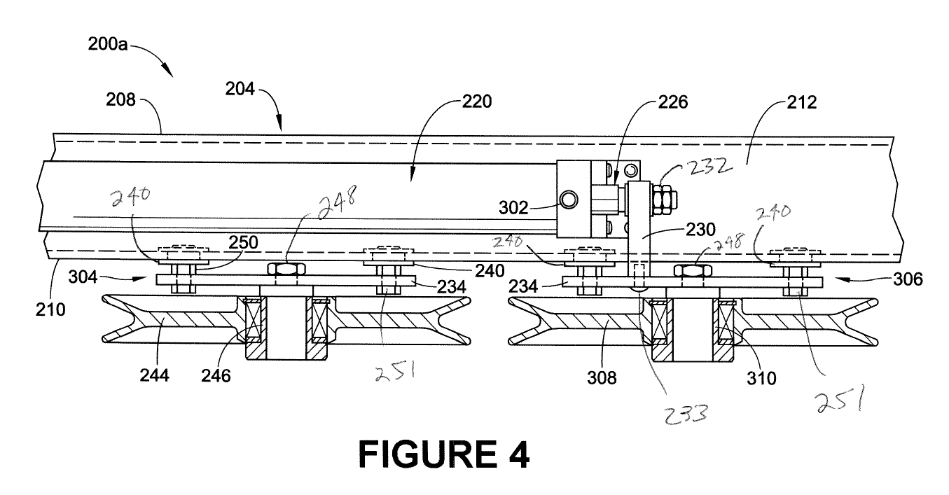

Referring now to FIG. 4, the link member 230 is retained on the piston rod 226. More specifically, a pair of flat washers and corresponding nuts 232 retain the link member 230 on the piston rod 226 at a position adjacent to a pair of opposing cup-shaped spring washers (not shown), which permit the link member to float laterally by a slight amount relative to the rod; hence, lateral stress is avoided on the piston rod 226.

Mechanical fasteners, such as, for example, screws 233, rigidly secure the link member 230 to a corresponding carriage support or plate member 234. The air cylinders 220, 222 are connected to air supply lines (not shown), which extend from an electronic control system (not shown). The control system controls a pressure of the air supply to the air cylinders 220, 222. The air pressure urges an outward movement of the piston rod 226 through the bore 228; the outward movement of the piston rod then pushes against and/or urges the link plate 230. Movement of the link plate 230 urges the corresponding carriage plate member 234 longitudinally of the track formed by the supporting flange 208, 210, 214, 216. The carriage plate member 234 is urged toward opposite, corresponding end portions of the beam frames 204, 206.

Carriage assemblies 304, 306 are supported for smooth, longitudinal movement along the inner flanges 210, 216 of the beam frames 204, 206. Each carriage assembly includes the generally planar carriage plate member 234. The plate member can include a polygonal shape, and the illustrated plate member is rectangular in shape. In the illustrated embodiment, the plate member 234 is situated in a plane generally perpendicular to the planes of the first and second interconnecting portions 212, 218 of the beam frames 204, 206. The plate member 234 is similarly situated in a plane generally parallel to the first and second inner flange members 210, 216. This plate member 234 is situated generally adjacent to the first and second air cylinders 220, 222. More specifically, the plate member 234 is situated adjacent to the outer surfaces (i.e., the surfaces facing toward a center of the apparatus 10) of the inner flange members 210, 216 while the first and second air cylinders 220, 222 are situated adjacent to the inner surfaces of the inner flange members. Longitudinal edges 236, 238 of the plate member generally coincide in a same transverse plane of which the distal, longitudinal edges 239, 241 of the beam frames 204, 206 (illustrated as part of inner flanges 210, 216) are situated.

A lateral length of the plate member 234 (i.e., a height of the plate member) is slightly greater than the clearance distance or gap G formed between distal edges 239, 241 of the first and second inner flange members 210, 216. In the preferred embodiment, the first interconnecting portion of the first beam frame 204 lies in a plane beyond a first longitudinal edge 236 of the carriage plate member 234 and the second interconnecting portion 218 of the second beam frame 206 lies in a plane beyond a second longitudinal edge 238 of the carriage plate member.

The dual rope tensioning apparatus 10 further includes a first and second pair of spaced apart upper guide member or wheels 240 and a first and second pair of spaced apart lower guide members 242, and a first and second pair of spaced apart upper guide members 245 and a first and second pair of spaced apart lower guide members 247. Each guide member 240, 242 is supported on one of a corresponding number of corners of one of the plate members 234. Similarly, each guide member 245, 247 is supported on one of four corners of another plate 234. Guide members 240 or 245 are situated proximate to the first longitudinal edge 236 of the plate member 234 and a second guide members 242 or 247 are situated proximate to the second longitudinal edge 238 of the plate member such that the guide members 240, 242 and 245, 247 are laterally spaced apart.

The guide members 240, 242 guide the carriage assembly along a longitudinal axis of the first and second beam frames 204, 206. Similarly, guide members 245, 247 guide the carriage assembly along a longitudinal axis of beam frames 205, 207.

More specifically in the preferred embodiment, the guide members 240, 242, 245, 247 are each generally spool-like guide wheels including a groove formed inward along a surface of the contact part or footprint of the wheel. Similarly, the groove of guide wheels 240 receives distal edge 239 of the corresponding inner flange 210. The groove of guide wheels 242 receives distal end 241 of inner flange 216. The groove of guide wheels 245 receives distal end 251 of inner flange 209 of beam frame 205. The groove of guide wheels 247 receives distal end 253 of inner flange 211 of beam frame 207. Guide members 240 engage and guide the carriage plate member 234 along the first inner flange 210 and guide members 242 engage and guide the plate member along the second inner flange 216. The guide members 240, 242 support the carriage plate member 234 for smooth and precise linear movement along the longitudinal axes of beam frames 204, 206. Similarly, guide members 245 engage and guide plate member 234 along inner flange 209 and guide members 247 engage and guide plate member 234 along inner flange 211 for linear movement along the longitudinal axes of frames 205, 207.

As one of the air cylinders moves the corresponding carriage plate member 234 longitudinally, the plate member similarly urges a corresponding rope guide sheave 244 to move longitudinally along the flanges 210, 216 or 209, 211 toward an end of the beam frame 204, 206 or 205, 207. The rope sheaves 244 are supported by the carriage assembly to freely rotate. Each rope sheave 244 is supported at an end portion of a shaft 246, which receives a threaded counterpart of a locking nut 248 situated on an inner side of the carriage plate member 234. Each shaft 246 can include an anti-friction center bearing mounted thereon to provide capability for free rotation on the rope sheave 244.

Shafts 250 are supported at the corner portions of the carriage plate member 234 in corresponding openings (not shown). The shafts 250 can be fabricated from stainless steel or a similar performing metal and non-metal material. The shafts 250 are mechanically fastened to the carriage plate member 234 by means of a fastener, such as, for example, a threaded nut 251. Shafts 250 support the guide wheels 240, 242, 245, 247.

FIG. 4 shows a top cross-sectional view of a single tensioning rope stretcher apparatus of FIG. 3. The first upper beam frame 204 is shown including the first outer flange 208 (in phantom) and the first inner flange 210 (in phantom). The first air cylinder 220 is suspended from an inner lower surface of the interconnecting member 212 by means of mechanical fasteners such as screws. A first carriage assembly 304 is situated next to a second carriage assembly 306 along the same longitudinally-extending axis. The first carriage assembly 304 includes a carriage plate 234 having a pair of upper guide members 240 and lower guide members 242 mounted to shafts formed therethrough at the opposing corners. Only the top mounted guide members 240 are illustrated. A first rope sheave 244 is supported at an end of the shaft. Although it is not shown in FIG. 4, the first assembly 304 is urged longitudinally forward by movement of the piston associated with the second air cylinder 222, which is mounted to the second beam frame 206 beneath the first, illustrated air cylinder 220. The second carriage assembly 306 similarly includes a carriage plate 234 having a second pair of upper guide members 240 and a second pair of lower guide members 242 mounted to shafts formed through opposing corners of the carriage plate. The top mounted guide members 240 are shown, which glide along the track formed by the distal longitudinal edge 239 of the inner flange 210. Lower guide members 242 guide along the track formed by the distal longitudinal edge 241 of inner flange 216. A second rope sheave 308 is supported at an end of a corresponding shaft 310. The second assembly 306 is urged in a direction opposite the first assembly 304 when the piston rod 226 associated with the first air cylinder 220 is urged along the longitudinal axis in a direction opposite the first assembly 304.

The carriage assemblies 304, 306 are affixed to their respective air cylinders 220, 222 using a self-aligning fixture. A power operated means actuates movement of each carriage assembly 304, 306 along the first and second beam frames 204, 206. The continuous rope R extends under a guide sheave 244 associated with a first end of the beam frames 204, 206, then at least 180° around each of the carriage supported sheaves, and finally over the guide sheave 308 associated with an opposite, second end of the rope stretcher apparatus. The rope R can be S-wrapped around two rope sheaves. The rope R then extends around the end portions of auxiliary rolls (not shown) of the papermaking or web processing machine.

As the sheaves 244, 308 travel along the beam frames 204, 206, they remove slack from the continuous rope R and apply a pre-set tension. This tension can be controlled using air regulators (not shown) that read in pounds per square inch (psi). Each psi instills about 4.12 physical pounds of weight to the tension of the rope.

The continuous rope R is contemplated for use with the present apparatus 10 has a diameter of approximately ½-inch and a length of from about 200 to about 400 feet. The rope can be made of spun nylon filaments or natural fibers. The rope R grips the tail of a web of material for threading the web through a series of processing rolls.

The exemplary embodiment has been described with reference to the preferred embodiment. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A tensioning apparatus, comprising:
a first frame spaced apart a distance from a second frame;
a first air cylinder mounted to said first frame;
a second air cylinder mounted to said second frame, said first and said second air cylinders are situated between said first and said second frames;
a carriage assembly situated adjacent to said first and said second air cylinders;
at least two pairs of guide members mounted on a support member on said carriage assembly, said pairs of guide members guide said carriage assembly along a longitudinal extent of said first and said second frames; wherein one of said pairs of said guide members travel along a distal end of said first frame and another of said pairs of guide members travel along a distal end of said second frame;
a power operated means actuating movement of said carriage assembly along said first and second frames; and,
a rope guide sheave supported by said carriage assembly for free rotation.

2. The tensioning apparatus of claim 1, wherein said first and said second beam frames are opposed C-shaped beam frames, wherein said first frame includes a first outer flange generally parallel to and spaced apart from a first inner flange, said first outer flange and said first inner flange depending downwardly from a first interconnecting portion;
said second frame including a second outer flange generally parallel to and spaced apart from a second inner flange, said second outer flange and said second inner flange extending upwardly from a second interconnecting portion toward said first frame;
wherein said first and said second interconnecting portions are generally parallel.

3. The tensioning apparatus of claim 2, wherein said first cylinder is positioned between said first inner flange and said first outer flange of said first frame, and said second cylinder is mounted between said second inner flange and said second outer flange of said second frame.

4. The tensioning apparatus of claim 3, wherein two of said pairs of guide members guides said support member along said first inner flange of said first beam frame and two of said pairs of guide members guides said support member along said second inner flange of said second beam frame.

5. The tensioning apparatus of claim 1, wherein:
said first and said second cylinders each comprises a piston rod; said piston rod receives an air supply from an air supply line, said piston rod is returnably received in a bore of a link member secured to said support member.

6. The tensioning apparatus of claim 1, further including at least one support means for supporting said first and second frames.

7. The tensioning apparatus of claim 6, wherein said support means includes end plates mounted at opposite ends of said first and second beam frames.

8. A tensioning apparatus, comprising:
a first elongate C-shaped beam frame spaced apart from a second elongate C-shaped beam frame;
at least one carriage assembly including a plate member situated adjacent to said first and said second C-shaped beam frames;
a first pair of guide members mounted on said carriage assembly proximate a first longitudinal edge of said plate member and a second pair of guide members mounted on said carriage assembly proximate an opposite longitudinal edge of said plate member such that said first and said second pairs of guide members are laterally spaced apart;
a power operated means actuates movement of said carriage assembly along said first and second C-shaped beams, and
a rope guide sheave supported by said carriage assembly for free rotation.

9. The tensioning apparatus of claim 8, wherein said first C-shaped beam frame includes a first outer flange generally parallel to and spaced apart from a first inner flange, said first outer flange and said first inner flange depending downwardly from opposite ends of a first interconnecting portion;
said second C-shaped beam frame including a second outer flange generally parallel to and spaced apart from opposite ends of a second inner flange, said second outer flange and said second inner flange extending upwardly from a second interconnecting portion;
wherein said first inner and outer flanges extend toward said second inner and outer flanges.

10. The tensioning apparatus of claim 9, further including:
a first air cylinder suspended from said first interconnecting portion of said first C-shaped beam frame; and,
a second air cylinder mounted on said second interconnecting portion of said second C-shaped beam frame;
wherein both said first and said second air cylinders are situated between said first and said second C-shaped beam frames.

11. The tensioning apparatus of claim 9, wherein said first pair of guide members engages and guides said carriage plate along a distal end of said first inner flange, and said second pair of said guide members engages and guides said carriage plate along a distal end of said second inner flange.

12. The tensioning apparatus of claim 8, wherein said first pair of guide members and said second pair of guide members are situated at opposing ends of said plate member.

13. The tensioning apparatus of claim 8, further including:
a piston rod included in each of said first and second cylinders, said piston rod receives an air supply from an air supply line, said piston rod is returnably received in a bore of a link member secured to said plate member.

14. The tensioning apparatus of claim 8, further including at least one support means for supporting said first and second C-shaped beam frames.

15. The tensioning apparatus of claim 14, wherein said support means includes end plates mounted at opposite ends of said first and second C-shaped beam frames.

16. A dual tensioning apparatus, comprising:
first and second pairs of beam frames, each of said first and second pairs of beam frames includes a first elongate beam frame spaced apart from a second elongate beam frame;
first and second pairs of air cylinders, wherein each pair of cylinders comprises a first cylinder suspended from one of said first elongate beam frames and a second cylinder mounted on one of said second elongate beam frames;
at least four pairs of guide members, wherein each pair of guide members returnably moves along an inner distal edge of one of said beam frames;
a plate member included on each of at least two carriage assemblies, wherein each plate member supports two pairs of said guide members, wherein each said plate member is situated generally perpendicular and adjacent to one of said first and second pairs of beam frames;
a power operated means for actuating movement of said carriage assemblies along said first and second pairs of beam frames, and
rope guide sheaves supported by each of said carriage assemblies for free rotation.

17. The dual tensioning apparatus of claim 16, wherein each of said first elongate beam frames includes a first outer flange generally parallel to and spaced apart from a first inner flange, said first outer flange and said first inner flange depending downwardly from a first interconnecting portion;
each of said second elongate beam frames includes a second outer flange generally parallel to and spaced apart from a second inner flange, said second outer flange and said second inner flange extending upwardly from a second interconnecting portion;
wherein said first inner and outer flanges oppose said second inner and outer flanges.

18. The dual tensioning apparatus of claim 16, wherein each of said pairs of guide members are mounted on said carriage assembly on opposed sides of said plate member such that each pair of said guide members are laterally spaced apart.

19. The dual tensioning apparatus of claim 17, wherein a first of said pairs of said guide members travels along a distal edge of said one of first inner flanges and a second of said pairs of guide members travels along a distal edge of one of said second flanges.

20. The dual tensioning apparatus of claim 16, wherein each of said beam frames are C-shaped.
